(19) United States
(12) Patent Application Publication
(10) Pub. No.: US 2025/0385446 A1
(43) Pub. Date: Dec. 18, 2025

(54) CONDUCTOR CONNECTORS FOR USE WITH HYBRID CONDUCTORS

(71) Applicant: AFL Telecommunications LLC, Duncan, SC (US)

(72) Inventors: Steven E. Kranz, Moore, SC (US); Matthew G. Welborn, Greenville, SC (US)

(21) Appl. No.: 19/231,922

(22) Filed: Jun. 9, 2025

Related U.S. Application Data
(60) Provisional application No. 63/659,412, filed on Jun. 13, 2024.

(51) Int. Cl. H01R 9/05; H01B 11/22; H01R 9/11; H01R 9/24

(52) U.S. Cl. CPC H01R 9/0524; H01B 11/22; H01R 9/11; H01R 9/2458

(57) ABSTRACT

A conductor connector includes a first outer body defining a first outer body interior, a second outer body defining a second outer body interior, and a core grip. The core grip includes a first leg, a second leg, and a third leg, the core grip defining a passage which extends through the first leg and the third leg, the core grip further including a connector accessory on the second leg. The first leg is housed in the first outer body interior and the third leg is housed in the second outer body interior.

### CROSS-REFERENCE TO RELATED APPLICATIONS

The present application claims priority to U.S. Provisional Patent Application Ser. No. 63/659,412 filed on Jun. 13, 2024, the disclosure of which is incorporated by reference herein in its entirety.

### FIELD

The present disclosure relates generally to conductor connectors and assemblies, and more particularly to conductor connectors and assemblies that facilitate the use of hybrid conductors.

### BACKGROUND

Conductors are utilized in a variety of environments for carrying electrical current and generally facilitating the transmission of electricity. Conductor connectors are utilized to connect the conductors to other conductors or to other components of the energy transmission assembly such as other conductor connectors or the tower. Examples of conductor connector accessories include dead ends, splices, terminals, repair sleeves, t-taps, t-connectors, jumper connectors, etc.

In many cases, the conductors are installed in relatively high tension. Due to the relatively high-tension environments, it is desirable for the connection between a conductor connector and conductor to be robust, thereby preventing relative movement between the conductor and conductor connector and/or disconnection of the conductor from the conductor connector. It is generally desirable in the industry for a conductor connector to properly function at no less than 95% of the associated conductor's rated breaking strength.

In a typical known conductor, the “core” is the physical strength member of the conductor, and outer aluminum stranding provides the path of electrical current flow. Conductor technology available to electrical utilities is rapidly improving. For example, conductor manufacturers are developing ways of monitoring aerial electrical systems by means of optical fiber sensing constructed within the conductor. As these sensing units require continuous stranding for a complete information path to be communicated, the sensing units must not be discontinued within a conductor connector used to hold the conductor under a high load value of tension at a transmission or distribution tower structure. As such, a device to grip such conductor while providing both a continuous electrical and continuous optical path is required.

One problem with existing technology is that the conductor core must be severed, or stopped, in order to be gripped properly and hold the tension of the conductor through the connector. As the new “hybrid” conductors which include sensing units require a continuous path, the core cannot be stopped within the conductor.

Accordingly, improved conductor connectors and assemblies, in particular for use with hybrid conductors, are desired in the art. In particular, improved conductor connectors and assemblies which address one or more of the above-described known deficiencies would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a conductor connector is provided. The conductor connector includes a first outer body defining a first outer body interior, a second outer body defining a second outer body interior, and a core grip. The core grip includes a first leg, a second leg, and a third leg, the core grip defining a passage which extends through the first leg and the third leg, the core grip further including a connector accessory on the second leg. The first leg is housed in the first outer body interior and the third leg is housed in the second outer body interior.

In accordance with another embodiment, a conductor assembly is provided. The conductor assembly includes a conductor connector and a conductor. The conductor connector includes a first outer body defining a first outer body interior, a second outer body defining a second outer body interior, and a core grip. The core grip includes a first leg, a second leg, and a third leg, the core grip defining a passage which extends through the first leg and the third leg, the core grip further including a connector accessory on the second leg. The first leg is housed in the first outer body interior and the third leg is housed in the second outer body interior. The conductor includes a conductor core, an optical fiber, and a first layer of conductor strands surrounding the conductor core and the optical fiber. The first layer terminates in the first outer body and the second outer body to define an exposed section of the conductor. The exposed section includes a portion of the conductor core and the optical fiber. The exposed section extends through the passage.

In accordance with another embodiment, a method for connecting a conductor to a conductor connector to form a conductor assembly is provided. The method includes removing one or more layers from a conductor to reveal an exposed section of the conductor. The method further includes inserting the exposed section into a passage in a core grip. The method further includes inserting first and third legs of the core grip into first and second outer bodies.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a side view of a conductor assembly in accordance with embodiments of the present disclosure;

FIG. 2 is a side cross-sectional view of a conductor assembly in accordance with embodiments of the present disclosure;

FIG. 3 is a perspective view of a portion of a conductor assembly in accordance with embodiments of the present disclosure;

FIG. 4 is an end view of outer body of a conductor connector in accordance with embodiments of the present disclosure;

FIG. 5 is a side perspective view of a conductor assembly, with first and second outer bodies removed for illustrative purposes, in accordance with embodiments of the present disclosure;

FIG. 6 is a perspective view of a core grip of a conductor connector with a conductor core extending therethrough in accordance with embodiments of the present disclosure;

FIG. 7 is the core grip of FIG. 6 with keepers of the conductor connector removed for illustrative purposes;

FIG. 8 is a side view of a portion of a conductor assembly, with a first outer body removed for illustrative purposes, in accordance with embodiments of the present disclosure;

FIG. 9 is a perspective view of a collet housing of a conductor connector in accordance with embodiments of the present disclosure;

FIG. 10 is a perspective view of a collet installed in a conductor assembly in accordance with embodiments of the present disclosure; and

FIG. 11 is a perspective view illustrating various layers of a conductor in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The present disclosure relates generally to improved conductor connectors and assemblies. In exemplary embodiments, such conductor connectors may be utilized with, and such conductor assemblies may include, hybrid conductors. Such conductor connectors and assemblies may advantageously facilitate secure connections of the associated conductors in high tension environments while also allowing continuous conductor paths, such as continuous electrical and continuous optical paths. In exemplary embodiments, such conductor connectors properly function at no less than 95% of the associated conductor's rated breaking strength.

Suitable conductor connectors in accordance with the present disclosure may in exemplary embodiments include a suitable connector accessory. Examples of suitable connectors accessories include, for example, dead ends, splices, terminals, repair sleeves, t-taps, t-connectors, jumper connectors, and other suitable connector accessories for connecting conductors to other conductors or to other components of an energy transmission assembly such as other conductor connectors or a tower.

Conductor connectors in accordance with the present disclosure may be utilized with, and conductor assemblies may include, conductors. In exemplary embodiments, a conductor in accordance with the present disclosure may be a hybrid conductor which includes both electrical and optical components. Alternatively, however, such conductor may include only electrical components.

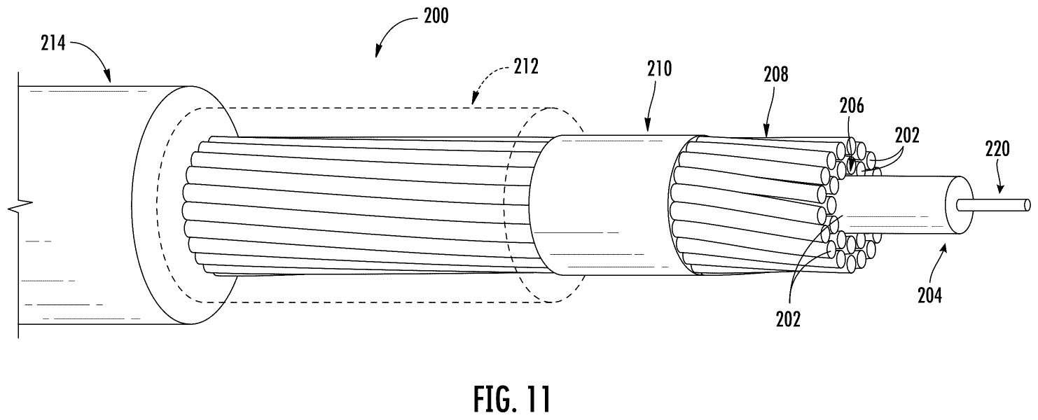

Referring briefly to FIG. 11, one embodiment of a conductor 200 with which a conductor connector 10 may be utilized is provided. In exemplary embodiments, conductors 200 with which conductor connectors 10 are utilized may be “jacketed” (or “covered”) conductors. In alternative embodiments, conductors 200 with which conductor connectors 10 are utilized may be non-jacketed or uncovered conductors. In exemplary embodiments, conductor connectors 10 in accordance with the present disclosure may be utilized with aluminum conductor composite reinforced (“ACCR”) conductors, aluminum conductor composite core (“ACCC”), aluminum conductor steel supported (“ACSS”) conductors, aluminum conductor composite supported (“ACCS”) conductors, aluminum conductor steel reinforced (“ACSR”) conductors, alumoweld (“AW”) conductors, all aluminum conductors (“AAC”), steel ground wire, or other suitable conductors. Conductors having single member cores, or multiple member cores (such as stranded cores) may be utilized. The core materials and outer layer materials may be the same or may be different.

As shown, in some embodiments, conductor 200 may include a plurality of conductor strands 202 which may be arranged as a central core 204 (which may include one, as shown, or more conductor strands 202) surrounded by one or more generally concentric layers of conductor strands, such as a first layer 206 and a second layer 208, each of which may include a plurality of conductor strands 202. The one or more layers 206, 208, may in some embodiments have a helical arrangement, with each strand 202 extending helically about a longitudinal axis of the conductor 200.

In exemplary embodiments, the conductor strands 202 of conductor 200 are formed from one or more metals. For example, in some embodiments, each conductor strand 202 is formed from steel and/or aluminum. The conductor strand(s) 202 of the core 204 may be formed from the same material as the strand(s) 206, 208 of the outer layer(s), or may be formed from a different material from the strand(s) 206, 208 of the outer layer(s). For example, the strand(s) 202 of the core 204 and/or the strand(s) of the outer layer(s) 206, 208 may be formed from steel, aluminum, aluminum fiber, aluminum reinforced with alumina fibers, carbon or glass fibers in a polymer matrix (such as an epoxy or a thermoplastic), or other suitable material(s).

In some embodiments, conductor 200 may further include one or more layers surrounding the conductor layers 206, 208. Such layers may, for example, be formed of non-conductive materials such as polymers. For example, in some embodiments, a polymer shield layer 210 may be provided on the outermost layer 208 of the conductor layers. Further, one or more jackets (such as two, three, four, or more jackets), such as an inner jacket 212 and an outer jacket 214, may be provided. Jackets 212, 214 may be formed from or include suitable polymers. For example, jackets 212, 214 may be formed from or include polyethylene, such as high density and/or crosslinked polyethylene, or another suitable thermoplastic.

In some exemplary embodiments, a conductor 200 may further include an optical component 220, which may be or include one or more optical fibers. The optical component 220 may, for example, extend through the core 204, such as through one or more strands 202 of the core 204.

In exemplary embodiments as discussed herein, an exposed section 230 of the conductor 200 may be defined. Such exposed section 230 may include only a portion of the core 204 of the conductor 200, with outer layers 206, 208, 210, 212, and/or 214 of the conductor 200 having been cut away and not included in the exposed section 230. However, the core 204 may be continuous through the exposed section 230, such that the electrical and/or optical paths through the conductor 200 are continuous paths. The outer layers 206, 208, 210, 212, and/or 214 may be removed to define the exposed section 230, and the conductor 200 may then be provided in a conductor connector 10 in accordance with the present disclosure. The outer layers 206, 208, 210, 212, and/or 214 may terminate in various portions of the conductor connector 10 while the core 204 is continuous through the conductor connector 10.

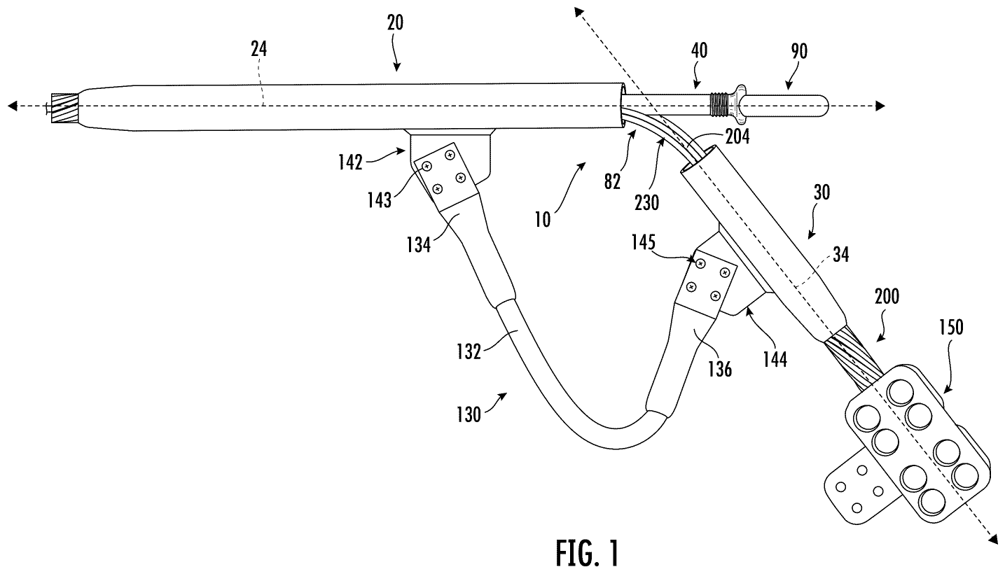

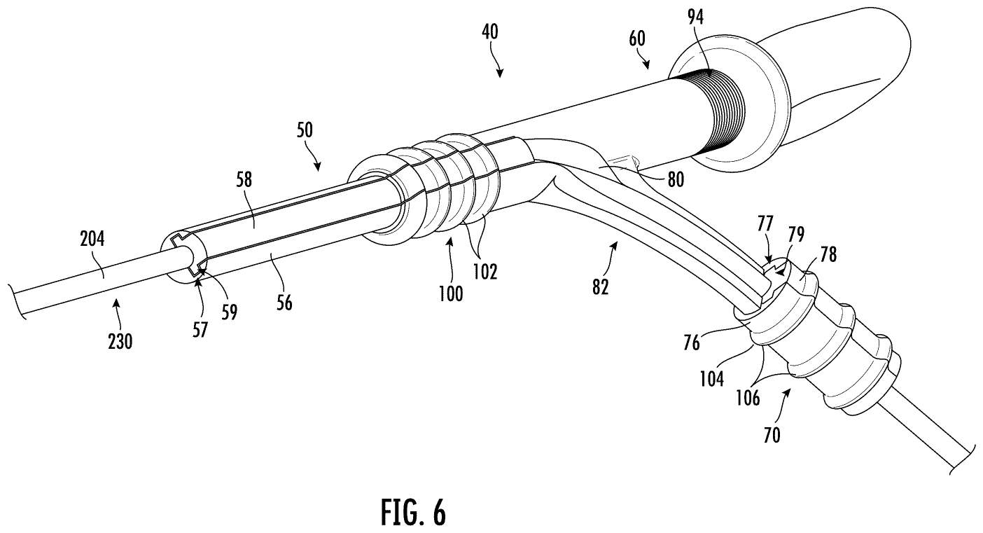

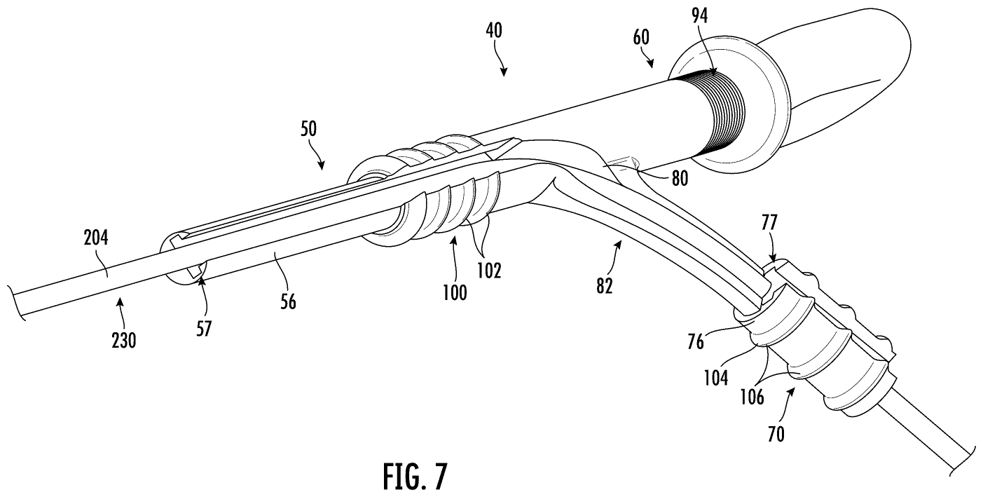

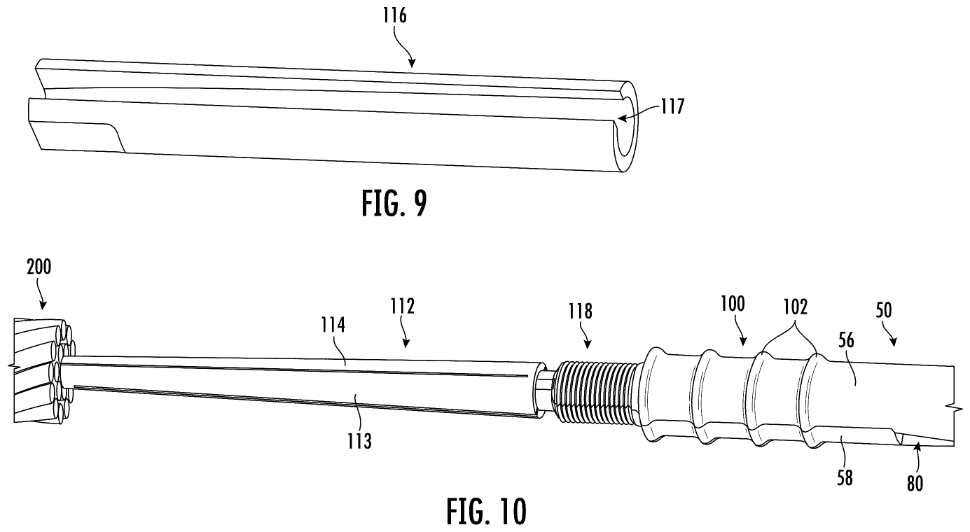

Referring now to FIGS. 1 through 10, embodiments of conductor connectors 10 and conductor assemblies which include such conductors 10 are provided. A conductor assembly in accordance with the present disclosure generally includes a conductor connector 10 and a conductor 200 disposed in the conductor connector 10.

As shown in FIGS. 1 through 4, a conductor connector 10 may include a first outer body 20 and a second outer body 30. The first outer body 20 may define a first outer body interior 22. Interior 22 may extend through the body 20 along a longitudinal axis 24 of the body 20, and may define opposing open ends of the body 20. The second outer body 30 may define a second outer body interior 32. Interior 32 may extend through the body 30 along a longitudinal axis 34 of the body 30, and may define opposing open ends of the body 30.

In exemplary embodiments, first and second outer bodies 20, 30 may have generally circular or oval cross-sectional profiles.

First and second outer bodies 20, 30 may each be formed from a metal, such as in exemplary embodiments aluminum.

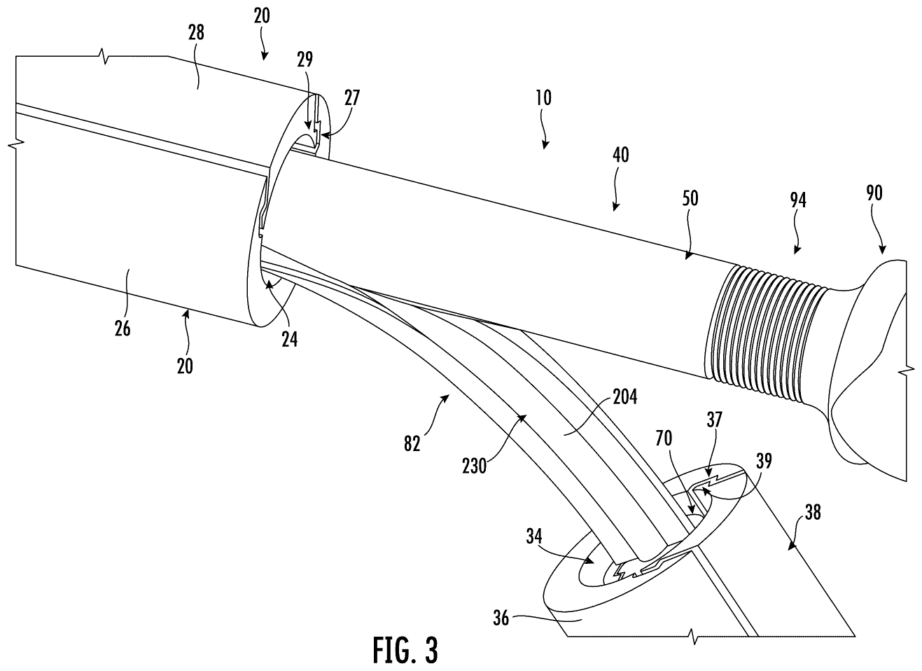

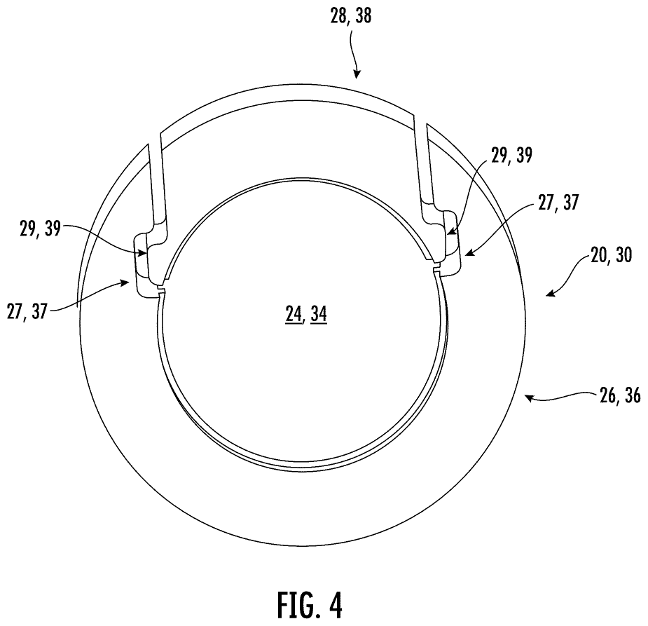

Referring specifically to FIGS. 3 and 4, in exemplary embodiments, one or both of the first and second outer bodies 20, 30 may include a base and a keeper. For example, in some embodiments, first outer body 20 may include a base 26 and a keeper 28 as shown. The base 26 and keeper 28 may each extend along the longitudinal axis 24 of the body 20, such as along the full length of the body 20. Thus, when the keeper 28 is removed from the base 26, a slot providing access to the interior 22 may be defined in the base 26 and may extend between and to the first and second open ends of the base 26. Base 26 and keeper 28 may together define a cross-sectional perimeter of the body 20, with the base 26 generally defining more of the perimeter than the keeper 28. Base 26 and keeper 28 may further define the interior 22 therebetween.

The keeper 28 may be movable relative to, such as in exemplary embodiments slidable along the longitudinal axis 24 of, the base 26 to connect the keeper 28 to the base 26. For example, one of base 26 or keeper 28 may include slots 27 defined therein, and the other of base 26 or keeper 28 may include tabs 29 extending therefrom. In the embodiments shown, base 26 may include slots 27 defined therein and keeper 28 may define tabs 29 extending therefrom. Tabs 29 may be insertable into slots 27 to connect the keeper 28 to the base 26. For example, tabs 29 may be slidable into slots 27 along the longitudinal axis 24 to connect the keeper 28 to the base 26.

Additionally or alternatively, in some embodiments, second outer body 30 may include a base 36 and a keeper 38 as shown. The base 36 and keeper 38 may each extend along the longitudinal axis 34 of the body 30, such as along the full length of the body 30. Thus, when the keeper 38 is removed from the base 36, a slot providing access to the interior 32 may be defined in the base 36 and may extend between and to the first and second open ends of the base 36. Base 36 and keeper 38 may together define a cross-sectional perimeter of the body 30, with the base 36 generally defining more of the perimeter than the keeper 38. Base 36 and keeper 38 may further define the interior 32 therebetween.

The keeper 38 may be movable relative to, such as in exemplary embodiments slidable along the longitudinal axis 34 of, the base 36 to connect the keeper 38 to the base 36. For example, one of base 36 or keeper 38 may include slots 37 defined therein, and the other of base 36 or keeper 38 may include tabs 39 extending therefrom. In the embodiments shown, base 36 may include slots 37 defined therein and keeper 38 may define tabs 39 extending therefrom. Tabs 39 may be insertable into slots 37 to connect the keeper 38 to the base 36. For example, tabs 39 may be slidable into slots 37 along the longitudinal axis 34 to connect the keeper 38 to the base 36.

Referring again generally to FIGS. 1 through 10, a conductor connector 10 in accordance with the present disclosure may further include a core grip 40. Core grip 40 may generally house the exposed section 230 of a conductor 200 which is provided therein.

Core grip 40 may include, for example, a first leg 50, a second leg 60, and a third leg 70. First leg 50 may extend along a longitudinal axis 52, second leg 60 may extend along a longitudinal axis 62, and third leg 70 may extend along a longitudinal axis 72. Core grip 40 may further include a passage 80 which is defined in and through the first leg 50 and the third leg 70. Passage 80 may extend through the first leg 50 and the third leg 70, and may define opposing opens ends of the first and third legs respectively. When assembled, the exposed section 230 of a conductor 200 may extend through the passage 80.

Core grip 40 may further include a connector accessory 90 on the second leg 60. In some embodiments as illustrated, the connector accessory 90 may be a dead end. Alternatively, other suitable connector accessories may be utilized. In some embodiments as illustrated, connector accessory 90 may be a separate component that is connected to second leg 60, such as via a threaded connection 94 as shown. Alternatively, connector accessory 90 may be an integral, monolithic component of the second leg 60.

As shown, in exemplary embodiments, the longitudinal axes 52, 62 of the first and second legs 50, 60 may be parallel, such as in exemplary embodiments coaxial. Further, in exemplary embodiments, the longitudinal axis 72 of the third leg 70 may be angled to one or both of longitudinal axes 52, 62. For example, as shown, in some embodiments, an obtuse angle 53 may be defined between the longitudinal axis 52 of the first leg 50 and the longitudinal axis 72 of the third leg 70.

Alternatively, however, the angle 53 may be a right angle or acute angle. Further, in some embodiments, an acute angle 63 may be defined between the longitudinal axis 62 of the second leg 60 and the longitudinal axis 72 of the third leg 70. Alternatively, however, the angle 63 may be a right angle or obtuse angle.

In some embodiments, the passage 80 may include a curvilinear portion 82. Such curvilinear portion 82 may be an intermediate portion of the passage 80 between portions that are defined in the first leg 50 and the third leg 70. The curvilinear portion 82 may extend along a curvilinear path rather than, for example, a linear path along a longitudinal axis. The portions defined in the first leg 50 and the third leg 70 may be linear portions which extend along the longitudinal axes 52, 72, respectively. The curvilinear portion 82 may provide a transition of the passage 80 in embodiments wherein the longitudinal axis 72 is angled to the longitudinal axis 52.

In exemplary embodiments, first, second, and third legs 50, 60, 70 may have generally circular or oval cross-sectional profiles.

First, second, and third legs 50, 60, 70, and core grip 40 generally, may each be formed from a metal, such as in exemplary embodiments steel, such as for example stainless steel.

Referring specifically to FIGS. 3, 5, 6, and 7, in exemplary embodiments, one or both of the first and third legs 50, 70 may include a base and a keeper. For example, in some embodiments, first leg 50 may include a base 56 and a keeper 58 as shown. The base 56 and keeper 58 may each extend along the longitudinal axis 52 of the first leg 50. When the keeper 58 is removed from the base 56, a slot providing access to the passage 80 may be defined in the first leg 50 and may extend to an open end of the base 56. Base 56 and keeper 58 may together define a cross-sectional perimeter of the first leg 50, with the base 56 generally defining more of the perimeter than the keeper 58. Base 56 and keeper 58 may further define a portion of the passage 80 therebetween.

The keeper 58 may be movable relative to, such as in exemplary embodiments slidable along the longitudinal axis 52 of, the base 56 to connect the keeper 58 to the base 56. For example, one of base 56 or keeper 58 may include slots 57 defined therein, and the other of base 56 or keeper 58 may include tabs 59 extending therefrom. In the embodiments shown, base 56 may include slots 57 defined therein and keeper 58 may define tabs 59 extending therefrom. Tabs 59 may be insertable into slots 57 to connect the keeper 58 to the base 56. For example, tabs 59 may be slidable into slots 57 along the longitudinal axis 52 to connect the keeper 58 to the base 56.

Additionally or alternatively, in some embodiments, third leg 70 may include a base 76 and a keeper 78 as shown. The base 76 and keeper 78 may each extend along the longitudinal axis 72 of the third leg 70. When the keeper 78 is removed from the base 76, a slot providing access to the passage 80 may be defined in the third leg 70 and may extend to an open end of the base 76. Base 76 and keeper 78 may together define a cross-sectional perimeter of the third leg 70, with the base 76 generally defining more of the perimeter than the keeper 78. Base 76 and keeper 78 may further define a portion of the passage 80 therebetween.

The keeper 78 may be movable relative to, such as in exemplary embodiments slidable along the longitudinal axis 72 of, the base 76 to connect the keeper 78 to the base 76. For example, one of base 76 or keeper 78 may include slots 77 defined therein, and the other of base 76 or keeper 78 may include tabs 79 extending therefrom. In the embodiments shown, base 76 may include slots 77 defined therein and keeper 78 may define tabs 79 extending therefrom. Tabs 79 may be insertable into slots 77 to connect the keeper 78 to the base 76. For example, tabs 79 may be slidable into slots 77 along the longitudinal axis 72 to connect the keeper 78 to the base 76.

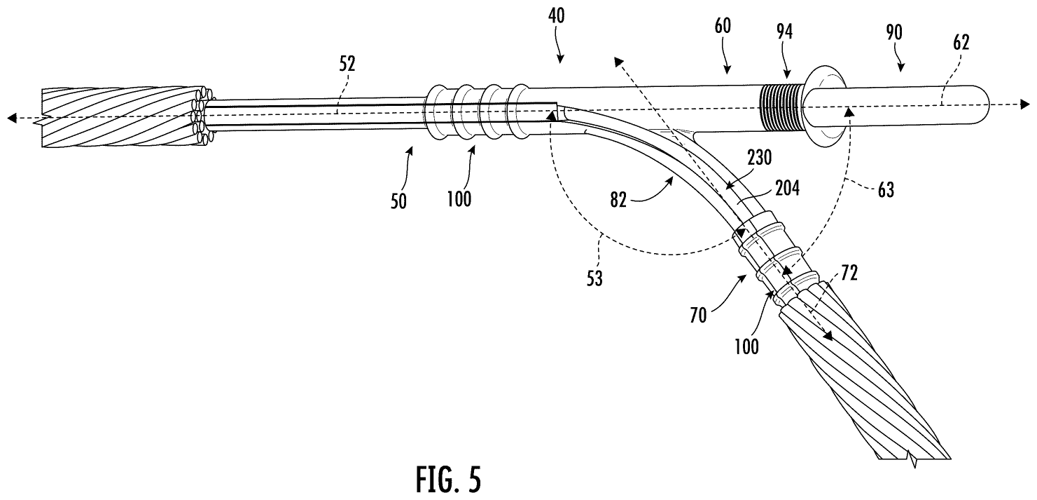

Referring now to FIGS. 5 through 8 and 10, in exemplary embodiments, first leg 50 and/or third leg 70 may include a compression portion. For example, first leg 50 may include compression portion 100 which includes a plurality of annular ridges 102 as shown. Additionally or alternatively, third leg 70 may include compression portion 104 which includes a plurality of annular ridges 106 as shown. The compressions portions 100, 104 are portions of the legs 50, 70, respectively, which may be compressed during assembly of the conductor assembly. For example, after insertion of the exposed section 230 of the conductor 200 into the passage 80, the compression portions 100, 104 may be compressed to connect the first leg 50 and/or second leg 70 to the exposed core 230 and conductor 230 generally. Swage dies or other suitable compression apparatus may be utilized to compress the leg(s).

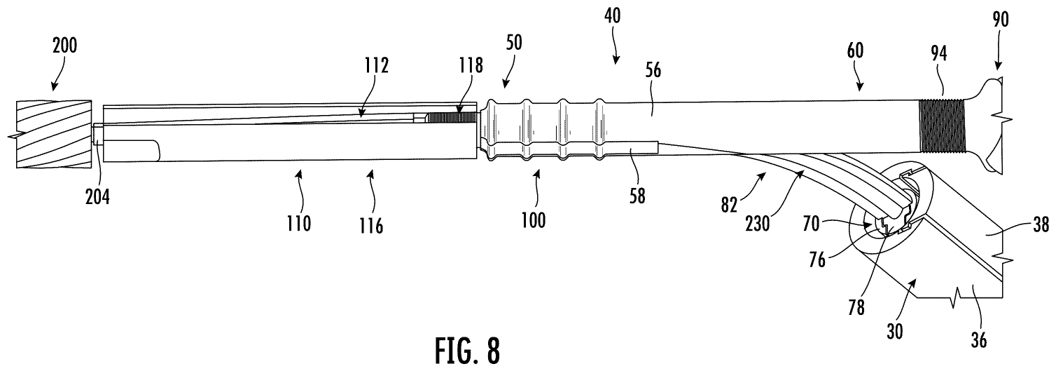

Referring now to FIGS. 8 through 10, first leg 50 and/or third leg 70 may further include a collet assembly. For example, as shown, first leg 50 may include a collet assembly 110 which may include a collet 112 and a collet housing 116. Collet 112 may be generally wedge-shaped and may include first and second portions or halves 113, 114. The collet 112, such as the portions 113, 114 thereof, may be provided around a portion of the exposed section 230 of the conductor 200. The collet 112 may then be inserted into the collet housing 116, which include a generally wedge-shaped interior 117 defined therein. During operation, tensile forces in the conductor 200 may be transmitted through the collet 112 to the collet housing 116 due, for example, to the wedge-shaped collet 112 and interior 117. Such transmission may in turn increase the connection forces between the collet 112 and housing 116, and thus between the conductor 200 and core grip 40 generally.

In some embodiments as illustrated, the collet housing 116 may be a separate component that is connected to first leg 50, such as via a threaded connection 118 as shown. Alternatively, collet housing 116 may be an integral, monolithic component of the first leg 50.

Additionally or alternatively, third leg 70 may include a collet assembly which may include a collet and a collet housing. Collet may be generally wedge-shaped and may include first and second portions or halves. The collet, such as the portions thereof, may be provided around a portion of the exposed section 230 of the conductor 200. The collet may then be inserted into the collet housing, which include a generally wedge-shaped interior defined therein. During operation, tensile forces in the conductor 200 may be transmitted through the collet to the collet housing due, for example, to the wedge-shaped collet and interior. Such transmission may in turn increase the connection forces between the collet and housing, and thus between the conductor 200 and core grip 40 generally.

In some embodiments as illustrated, the collet housing may be a separate component that is connected to third leg 70, such as via a threaded connection as shown. Alternatively, collet housing may be an integral, monolithic component of the third leg 70.

Referring again to FIGS. 1 through 3, when the conductor connector 10 and/or assembly is assembled, the first outer body 20 may surround the first leg 50 such that the first leg 50 is housed in the first outer body interior 22. For example, the base 56, keeper 58, and/or compression portion 100 may be housed in the interior 22. Further, the second outer body 30 may surround the third leg 70 such that the third leg 70 is housed in the second outer body interior 32. For example, the base 76, keeper 78, and/or compression portion 104 may be housed in the interior 32. Outer bodies 20, 30 may thus serve to house and protect portions of the exposed section 230 of the conductor 200 and portions of the core grip 40 that are connected to the exposed section 230.

In some embodiments, curvilinear portion 82 may be exposed between and thus not surrounded by first or second bodies 20, 30.

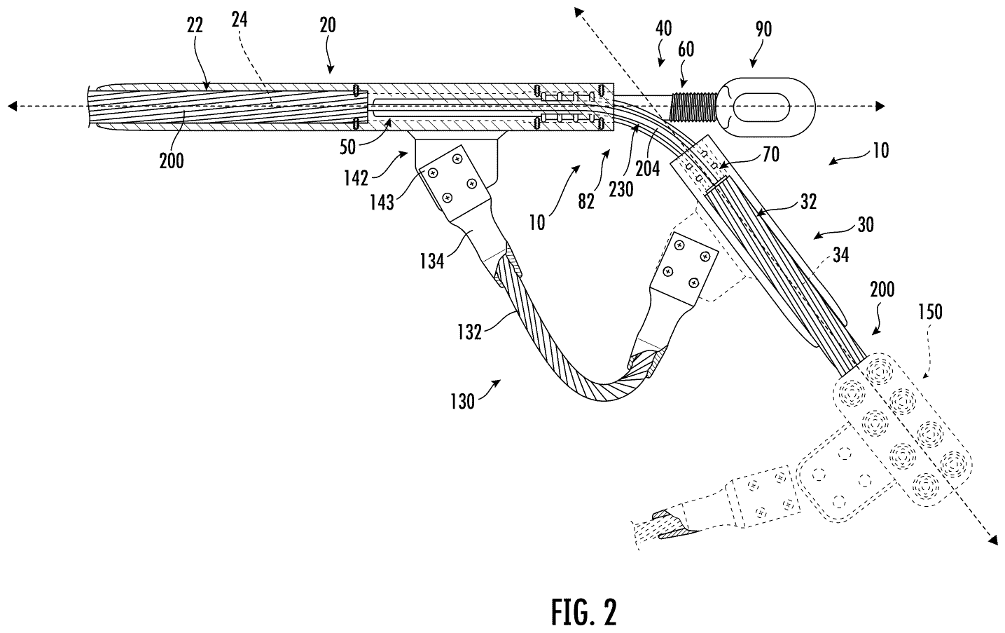

Referring now to FIGS. 1 and 2, in exemplary embodiments, conductor connector 10 and/or assembly may further include a jumper 130. Jumper 130 may extend between and connect the first outer body 20 and the second outer body 30. Such connection may provide an electrical connection between first outer body 20 and second outer body 30. Alternatively, jumper 130 may extend between and connect the first outer body 20 and a separate bolted terminal 150 which may be provided on conductor 200 as shown.

For example, jumper 130 may include a jumper body 132, a first jumper connector 134, and a second jumper connector 136. The first and second jumper connectors 134, 136 may be disposed at opposing ends of the jumper body 132, and may connect to the first and second outer bodies 20, 30, respectively. For example, first outer body 20 may further include a jumper pad 142, and first jumper connector 134 may be placed into contact with jumper pad 142 and connected to jumper pad 142 via, for example, mechanical fasteners 143. Further, for example, second outer body 30 may further include a jumper pad 144, and second jumper connector 136 may be placed into contact with jumper pad 144 and connected to jumper pad 144 via, for example, mechanical fasteners 145.

In exemplary embodiments, the jumper 130, such as the jumper body 132, first jumper connector 134, and second jumper connector 136, are formed from a metal, such as in exemplary embodiment aluminum.

As illustrated in FIG. 2, when a conductor 200 is assembled into a conductor connector 10 to form a conductor assembly, the one or more layers 206, 208, 210, 212, and/or 214 may be removed to define the exposed section 230. Thus, the one or more layers 206, 208, 210, 212, and/or 214 may terminate in the first outer body 20 and in the second outer body 30, with the exposed section 230 disposed therebetween. In exemplary embodiments, jumper 130 may provide an electrical connection for the one or more layers 206, 208, 210, 212, and/or 214 in the outer bodies 20, 30.

The present disclosure further provides methods for connecting conductors 200 to conductor connectors 10 to form conductor assemblies. A method in accordance with the present disclosure may include, for example, removing one or more layers 206, 208, 210, 212, and/or 214 from a conductor 200 to reveal an exposed section 230 of the conductor 200, as discussed herein. The method may further include, for example, inserting the exposed section 230 into a passage 80 in a core grip 40, as discussed herein.

In some embodiments, for example, the method may further include connecting keepers 58 and/or 78 to bases 56 and/or 76, respectively, to contain and secure the exposed section 230 in the passage 80 after the exposed section 230 is inserted into the passage 80 as discussed herein.

In some embodiments, for example, the method may further include connecting a collet 112 to the exposed section 230, as discussed herein. In some embodiments, for example, the method may further include connecting the collet 112 to a collet housing 116, as discussed herein.

In some embodiments, for example, the method may further include compressing the core grip 40, such a first and third legs 50, 70 thereof, as discussed herein. Such compressing step may occur after the exposed section 230 is inserted into the passage 80. In some embodiments, such compression may occur at compression portions 100, 104, as discussed herein.

In some embodiments, for example, the method may further include inserting the first and third legs 50, 70 into first and second outer bodies 20, 30, respectively, as discussed herein.

Further aspects of the invention are provided by one or more of the following embodiments:

A conductor connector, including a first outer body defining a first outer body interior, a second outer body defining a second outer body interior, and a core grip. The core grip includes a first leg, a second leg, and a third leg, the core grip defining a passage which extends through the first leg and the third leg, the core grip further including a connector accessory on the second leg. The first leg is housed in the first outer body interior and the third leg is housed in the second outer body interior.

A conductor assembly, including a conductor connector and a conductor. The conductor connector includes a first outer body defining a first outer body interior, a second outer body defining a second outer body interior, and a core grip. The core grip includes a first leg, a second leg, and a third leg, the core grip defining a passage which extends through the first leg and the third leg, the core grip further including a connector accessory on the second leg. The first leg is housed in the first outer body interior and the third leg is housed in the second outer body interior. The conductor includes a conductor core, an optical fiber, and a first layer of conductor strands surrounding the conductor core and the optical fiber. The first layer terminates in the first outer body and the second outer body to define an exposed section of the conductor. The exposed section includes a portion of the conductor core and the optical fiber. The exposed section extends through the passage.

A conductor connector, conductor assembly, and/or method of any one or more embodiments shown or described herein, further including a jumper extending between and connecting the first outer body and the second outer body.

A conductor connector, conductor assembly, and/or method of any one or more embodiments shown or described herein, wherein the first outer body and the second outer body each include a base and a keeper, the keeper movable relative to the base to connect the keeper to the base.

A conductor connector, conductor assembly, and/or method of any one or more embodiments shown or described herein, wherein the first outer body and the second outer body are each formed from aluminum.

A conductor connector, conductor assembly, and/or method of any one or more embodiments shown or described herein, wherein the first leg and the third leg each include a base and a keeper, the keeper movable relative to the base to connect the keeper to the base.

A conductor connector, conductor assembly, and/or method of any one or more embodiments shown or described herein, wherein the first leg and the third leg each include a compression portion, the compression portion including a plurality of annular ridges.

A conductor connector, conductor assembly, and/or method of any one or more embodiments shown or described herein, wherein the first leg includes a collet assembly, the collect assembly including a collet and a collet housing.

A conductor connector, conductor assembly, and/or method of any one or more embodiments shown or described herein, wherein a longitudinal axis of the first leg and a longitudinal axis of the second leg are parallel, and wherein a longitudinal axis of the third leg is angled to the longitudinal axis of the first leg and the longitudinal axis of the second leg.

A conductor connector, conductor assembly, and/or method of any one or more embodiments shown or described herein, wherein a portion of the passage between the first leg and the third leg is curvilinear.

A conductor connector, conductor assembly, and/or method of any one or more embodiments shown or described herein, wherein the core grip is formed from a steel.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A conductor connector, comprising:
a first outer body defining a first outer body interior;
a second outer body defining a second outer body interior;
a core grip, the core grip comprising a first leg, a second leg, and a third leg, the core grip defining a passage which extends through the first leg and the third leg, the core grip further comprising a connector accessory on the second leg,
wherein the first leg is housed in the first outer body interior and the third leg is housed in the second outer body interior.

2. The conductor connector of claim 1, further comprising a jumper extending between and connecting the first outer body and the second outer body.

3. The conductor connector of claim 1, wherein the first outer body and the second outer body each comprise a base and a keeper, the keeper movable relative to the base to connect the keeper to the base.

4. The conductor connector of claim 1, wherein the first outer body and the second outer body are each formed from aluminum.

5. The conductor connector of claim 1, wherein the first leg and the third leg each comprise a base and a keeper, the keeper movable relative to the base to connect the keeper to the base.

6. The conductor connector of claim 1, wherein the first leg and the third leg each comprise a compression portion, the compression portion comprising a plurality of annular ridges.

7. The conductor connector of claim 1, wherein the first leg comprises a collet assembly, the collect assembly comprising a collet and a collet housing.

8. The conductor connector of claim 1, wherein a longitudinal axis of the first leg and a longitudinal axis of the second leg are parallel, and wherein a longitudinal axis of the third leg is angled to the longitudinal axis of the first leg and the longitudinal axis of the second leg.

9. The conductor connector of claim 1, wherein a portion of the passage between the first leg and the third leg is curvilinear.

10. The conductor connector of claim 1, wherein the core grip is formed from a steel.

11. A conductor assembly, comprising:
a conductor connector, the conductor connector comprising:
a first outer body defining a first outer body interior;
a second outer body defining a second outer body interior;
a core grip, the core grip comprising a first leg, a second leg, and a third leg, the core grip defining a passage which extends through the first leg and the third leg, the core grip further comprising a connector accessory on the second leg,
wherein the first leg is housed in the first outer body interior and the third leg is housed in the second outer body interior; and
a conductor, the conductor comprising a conductor core, an optical fiber, and a first layer of conductor strands surrounding the conductor core and the optical fiber, the first layer terminating in the first outer body and the second outer body to define an exposed section of the conductor, the exposed section comprising a portion of the conductor core and the optical fiber, the exposed section extending through the passage.

12. The conductor assembly of claim 11, further comprising a jumper extending between and connecting the first outer body and the second outer body.

13. The conductor assembly of claim 11, wherein the first outer body and the second outer body each comprise a base and a keeper, the keeper movable relative to the base to connect the keeper to the base.

14. The conductor assembly of claim 11, wherein the first outer body and the second outer body are each formed from aluminum.

15. The conductor assembly of claim 11, wherein the first leg and the third leg each comprise a base and a keeper, the keeper movable relative to the base to connect the keeper to the base.

16. The conductor assembly of claim 11, wherein the first leg and the third leg each comprise a compression portion, the compression portion comprising a plurality of annular ridges.

17. The conductor assembly of claim 11, wherein the first leg comprises a collet assembly, the collect assembly comprising a collet and a collet housing.

18. The conductor assembly of claim 11, wherein a longitudinal axis of the first leg and a longitudinal axis of the second leg are parallel, and wherein a longitudinal axis of the third leg is angled to the longitudinal axis of the first leg and the longitudinal axis of the second leg.

19. The conductor assembly of claim 11, wherein a portion of the passage between the first leg and the third leg is curvilinear.

20. The conductor assembly of claim 11, wherein the core grip is formed from a steel.
